(19) United States
(12) Patent Application Publication
(10) Pub. No.: US 2026/0370319 A1
(43) Pub. Date: Nov. 19, 2026

(54) METHODS FOR INTER-SATELLITE MEASUREMENT AND HANDOVER FOR NON-TERRESTRIAL NETWORK IN WIRELESS COMMUNICATIONS

(71) Applicant: MediaTek Singapore Pte. Ltd., Singapore (SG)

(72) Inventors: Abdelkader MEDLES, Cambridge (GB); Gilles CHARBIT, Cambridge (GB); Hsuan-Li LIN, Hsinchu City (TW)

(73) Assignee: MediaTek Singapore Pte. Ltd., Singapore (SG)

(21) Appl. No.: 19/475,689

(22) PCT Filed: Nov. 7, 2024
(86) PCT No.: PCT/CN2024/130513

§ 371 Date: Oct. 15, 2025

Related U.S. Application Data
(60) Provisional application No. 63/605,615, filed on Dec. 4, 2023.

(51) Int. Cl. H04B 7/185; H04W 8/24; H04W 36/00

(52) U.S. Cl. CPC H04B 7/18541; H04W 8/24; H04W 36/0085

(57) ABSTRACT

Various solutions for inter-satellite measurement and handover for non-terrestrial network (NTN) in wireless communications are described. An apparatus may report user equipment (UE) capability information to a network node of a wireless network. The network node is associated with a first satellite and the UE capability information indicates whether an interruption for antenna re-steering is required for an inter-satellite measurement or handover. Then, the apparatus may receive a configuration of the inter-satellite measurement or handover from the network node. Specifically, the configuration is based on the UE capability information. The apparatus may further perform the inter-satellite measurement or handover according to the configuration.

### CROSS REFERENCE TO RELATED PATENT APPLICATION(S)

The present disclosure is part of a non-provisional application claiming the priority benefit of U.S. Patent Application No. 63/605,615, filed 4 Dec. 2023, the content of which herein being incorporated by reference in its entirety.

### TECHNICAL FIELD

The present disclosure is generally related to wireless communications and, more particularly, to inter-satellite measurement and handover for non-terrestrial network (NTN) with respect to user equipment (UE) and network node in wireless communications.

### BACKGROUND

Unless otherwise indicated herein, approaches described in this section are not prior art to the claims listed below and are not admitted as prior art by inclusion in this section.

In 3^{rd} Generation Partnership Project (3GPP) Release 17, NTN is introduced as a terminal-satellite direct communication technology based on the new radio (NR) interface. With the integration of satellite network and ground cellular network (e.g., 5^{th} generation (5G) network), NTN may provide ubiquitous coverage without being restricted by terrain and landform. As NTN continues to evolve in the 5G-Advanced stage, it has become an important part of 3GPP Release 18 work plan. Currently, NTN may include two workgroups: Internet-of-Things (IoT) NTN and New Radio (NR) NTN. IoT NTN focuses on satellite IoT services that support low-complexity enhanced machine-type communication (eMTC) and narrowband Internet-of-things (NB-IoT) UEs. NR NTN uses the 5G NR framework to enable direct connection between satellites and smartphones to provide voice and data services.

For satellite communications, a large antenna or phase array at the UE side may be required to close the link budget and this type of UE may be referred to as a very small aperture terminal (VSAT) UE. In an NTN, due to the satellite is moving, a UE may need to perform inter-satellite measurement (e.g., measurement on neighbor satellite(s) while being connected to the source satellite) and/or inter-satellite handover (e.g., from a source satellite to a target satellite), so as to ensure normal transmission/reception during a long connection time and to avoid radio link failure. The inter-satellite measurement/handover may or may not require a serving cell processing interruption, depending on whether the UE needs to re-steer its antenna away from the serving satellite. However, in 3GPP Release 18, the detailed operations of inter-satellite measurement/handover have not been fully discussed yet and some issues need to be solved. For example, one of the issues relates to network not being able to properly configure the inter-satellite measurement/handover without the knowledge of whether the serving cell processing interruption is required.

Therefore, there is a need to provide proper schemes to address the above-described issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and apparatus pertaining to inter-satellite measurement and handover for NTN in wireless communications. It is believed that the above-described issues would be avoided or otherwise alleviated by implementing one or more of the proposed schemes described herein.

In one aspect, a method may involve an apparatus reporting UE capability information to a network node of a wireless network, wherein the network node is associated with a first satellite and the UE capability information indicates whether an interruption for antenna re-steering is required for an inter-satellite measurement or handover. The method may also involve the apparatus receiving a configuration of the inter-satellite measurement or handover from the network node, wherein the configuration is based on the UE capability information. The method may further involve the apparatus performing the inter-satellite measurement or handover according to the configuration.

In one aspect, a method may involve a network node receiving UE capability information from an apparatus, wherein the network node is associated with a first satellite and the UE capability information indicates whether an interruption for antenna re-steering is required for an inter-satellite measurement or handover. The method may also involve the network node transmitting a configuration of the inter-satellite measurement or handover to the apparatus, wherein the configuration is based on the UE capability information.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of UE antenna re-steering in accordance with an implementation of the present disclosure.

FIG. 2 is a diagram depicting an example scenario of a communication environment in which various solutions and schemes in accordance with the present disclosure may be implemented.

FIG. 3 is a diagram depicting an example scenario of a UE preparing for an inter-satellite measurement/handover in accordance with an implementation of the present disclosure.

FIG. 4 is a diagram depicting an example scenario of different UE beam configurations in accordance with an implementation of the present disclosure.

FIG. 5 is a block diagram of an example communication system in accordance with an implementation of the present disclosure.

FIG. 6 is a flowchart of an example process in accordance with an implementation of the present disclosure.

FIG. 7 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to inter-satellite measurement and handover for NTN in wireless communications. According to the present disclosure, a number of possible solutions may be implemented separately or jointly. That is, although these possible solutions may be described below separately, two or more of these possible solutions may be implemented in one combination or another.

In the present disclosure, NTN refers to a network that uses radio frequency (RF) and information processing resources carried on high, medium and low orbit satellites or other high-altitude communication platforms to provide communication services for UEs. According to the load capacity on the satellite, there are two typical scenarios, namely: transparent payload and regenerative payload. In transparent payload mode, the satellite does not process the signal and waveform in the communication service but, rather, only functions as an RF amplifier to forward data. In regenerative payload mode, the satellite, other than RF amplification, also has the processing capabilities of modulation/demodulation, coding/decoding, switching, routing and so on. It is noteworthy that the present disclosure is motivated by, but not limited to, an NTN scenario.

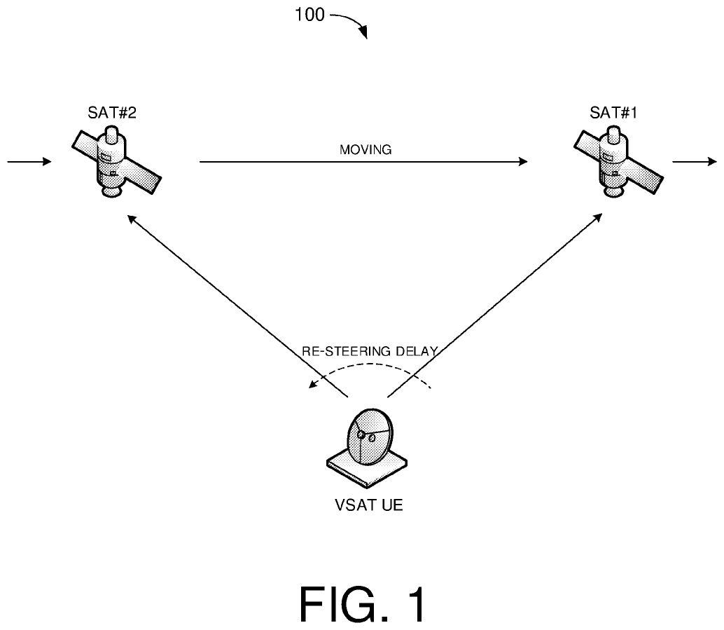

To prepare for inter-satellite measurement/handover, a UE may or may not need to re-steer the antenna away from the serving satellite depending on the UE's capability. If the UE needs to re-steer its antenna away from the serving satellite, then a serving cell processing interruption (e.g., in seconds or even tens of seconds) will be induced to cause service delay. For example, the UE may be a VSAT UE using a mechanical steering antenna, and the rotor required to move the antenna may have a speed of 2-10 degrees per second. FIG. 1 illustrates an example scenario 100 of UE antenna re-steering in accordance with an implementation of the present disclosure. Scenario 100 involves a VSAT UE in wireless communication with satellite 1 (denoted as SAT #1) initially. Then, with the satellites moving as time advances, the area where the VSAT UE is located will be no longer served by satellite 1 and be served by satellite 2 (denoted as SAT #2) instead. To ensure normal transmission/reception and to avoid radio link failure, the VSAT UE may need to perform an inter-satellite handover to switch the service link from satellite 1 to satellite 2. Alternatively, the VSAT UE may need to re-steer the antenna away from the serving satellite (e.g., satellite 1) and towards the neighbor satellite (e.g., satellite 2) to perform an inter-satellite measurement. Consequently, the inter-satellite measurement/handover may require a serving cell processing interruption due to the re-steering delay. It should be noted that, in 3GPP Release 18, the detailed operations of inter-satellite measurement/handover have not been fully discussed yet and some issues remain unsolved, including the issue of the network unable to properly configure the inter-satellite measurement/handover without the knowledge of whether the serving cell processing interruption is required.

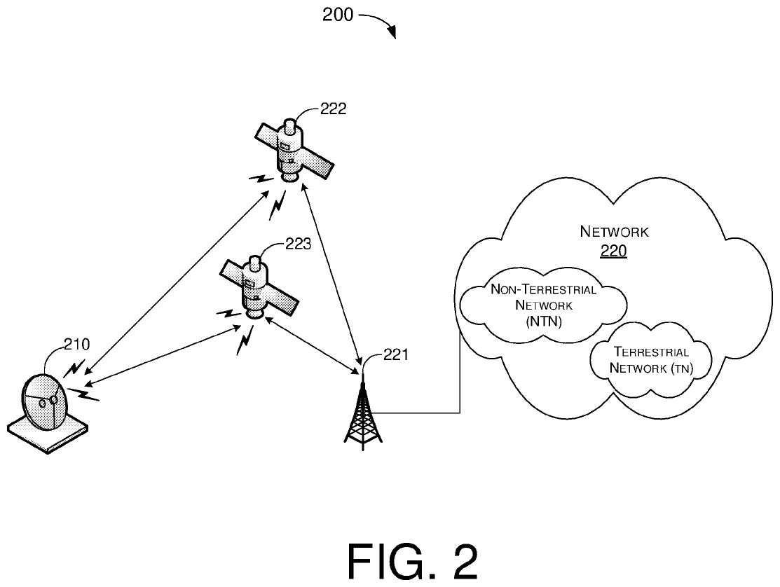

In view of the above, the present disclosure proposes a number of schemes pertaining to inter-satellite measurement and handover for NTN in wireless communications. FIG. 2 illustrates an example scenario 200 of a communication environment in which various solutions and schemes in accordance with the present disclosure may be implemented. Scenario 200 involves a UE 210 (e.g., a VSAT UE) in wireless communication with a network 220 (e.g., a wireless network including an NTN and a TN) via at least one terrestrial network node 221 (e.g., a base station (BS) such as an evolved Node-B (eNB), a next generation Node-B (gNB), or a transmission/reception point (TRP)) and one or more non-terrestrial network nodes 222-223 (e.g., satellite(s)). In some implementations, the terrestrial network node 221 and each of the non-terrestrial network nodes 222-223 may form an NTN cell for wireless communication with the UE 210. In some implementations, the terrestrial network node 221 and the non-terrestrial network node 222/223 may communicate through an NTN or satellite gateway (not shown). In such communication environment as shown in FIG. 2, the UE 210, the terrestrial network node 221, and the non-terrestrial network nodes 222-223 may implement various schemes pertaining to inter-satellite measurement and handover for NTN in wireless communications in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

According to the proposed schemes of the present disclosure, a UE (e.g., a VSAT UE) may report its capability information indicating whether an interruption for antenna re-steering is required for an inter-satellite measurement/handover to the network node associated with the serving/source satellite. Then, the UE may receive a configuration of the inter-satellite measurement/handover from the network node. Specifically, the configuration is based on the UE capability information. For instance, if the UE capability information indicates that an interruption for antenna re-steering is required for the inter-satellite measurement/handover, the network node may allocate, in the configuration, an interruption time for the measurement of a neighbor satellite or for the handover to a target satellite. Accordingly, the UE may perform the inter-satellite measurement/handover according to the configuration that is suited to the UE's capability reflecting whether an interruption for antenna re-steering is required for inter-satellite measurement/handover.

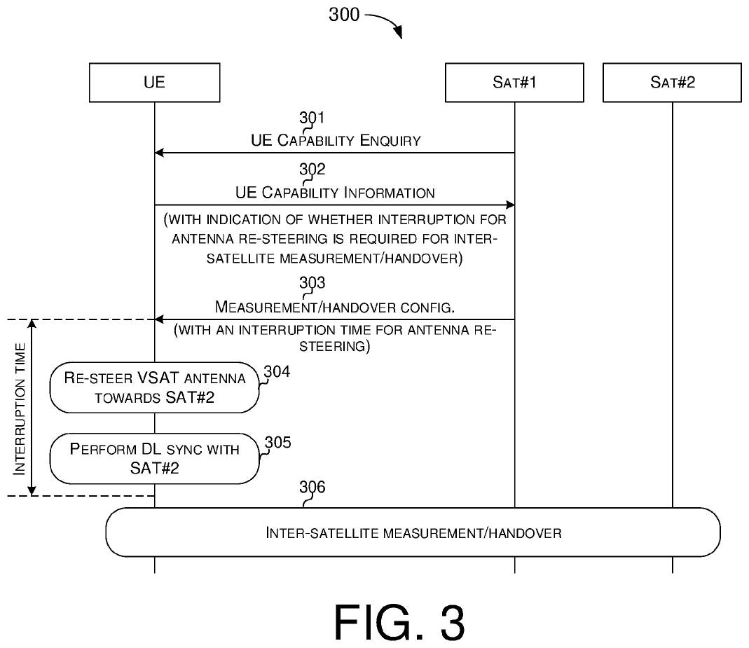

FIG. 3 illustrates an example scenario 300 of a UE preparing for an inter-satellite measurement/handover in accordance with an implementation of the present disclosure. In step 301, the UE (e.g., VSAT UE) may receive a UE Capability Enquiry message from the serving/source satellite (denoted as SAT #1). In step 302, the UE may transmit a UE Capability Information message including an indication of whether an interruption for antenna re-steering is required for inter-satellite measurement/handover to the serving/source satellite. In step 303, the UE may receive a measurement/handover configuration (e.g., in an RRC Reconfiguration message) from the serving/source satellite. Specifically, the measurement/handover configuration may include the information of the neighbor/target satellite(s), and an interruption time for antenna re-steering from the serving/source satellite. In step 304, the UE may re-steer the (VSAT) antenna towards the neighbor/target satellite (denoted as SAT #2). In step 305, the UE may perform downlink (DL) synchronization with the neighbor/target satellite once the antenna is re-steered to point to the target satellite. It is noteworthy that the interruption time is configured with a length that is enough for the UE to complete the preparations (i.e., antenna re-steering and target satellite synchronization) for the inter-satellite measurement/handover. In step 306, the UE may perform the inter-satellite measurement/handover according to the configuration. It is noteworthy that the interruption time is configured with a length that is enough for the UE to complete the preparations (i.e., antenna re-steering and target satellite synchronization) for the inter-satellite measurement/handover.

Under a first proposed scheme of the present disclosure, a UE (e.g., a VSAT UE) may indicate, in the UE capability information, the need or no need of an interruption for measurement/handover associated with certain satellite(s), based on the directivity of UE beam. For instance, the wider the UE beam (e.g., less number of antennas, or smaller antenna aperture), the more satellites can be potentially viewed by the UE for measurement/handover without the need of an interruption for antenna re-steering. In some implementations, the UE capability information may include an indication that the interruption for antenna re-steering is required for inter-satellite measurement/handover associated with certain satellite(s), and/or an antenna re-steering duration/delay for the certain satellite(s) with which the interruption for antenna re-steering is required for inter-satellite measurement/handover. In some implementations, the UE capability information may include an indication that the interruption for antenna re-steering is not required for inter-satellite measurement/handover associated with certain satellite(s), and/or a number of the certain satellite(s) with which the interruption for antenna re-steering is not required for inter-satellite measurement/handover.

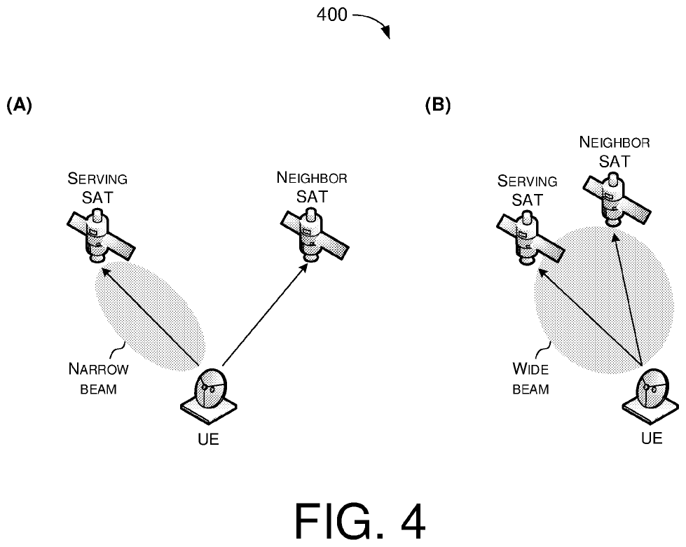

In some implementations, the UE may indicate beam width information in the UE capability information, such that the network node (e.g., gNB and/or satellite) may determine which satellite(s) the UE can perform measurement/handover without the need of an interruption for antenna re-steering. The beam width information may include a beam width (e.g., 3 dB) in degrees or a beam width angle in general, or include the number of (Rx and/or Tx) antennas or the antenna array configuration, or include the antenna aperture and selectivity (e.g., for parabolic antenna). FIG. 4 illustrates an example scenario 400 of different UE beam configurations in accordance with an implementation of the present disclosure. Part A of FIG. 4 depicts a UE beam configuration with a narrower beam width to cover a single satellite (e.g., the serving satellite) at a time, while part (B) of FIG. 4 depicts another UE beam configuration with a wider beam width to cover two satellites (e.g., the serving satellite and a neighbor satellite) at a time.

In some implementations, for an inter-satellite measurement without the need of an interruption for antenna re-steering, either UE or the network node may compensate the measurement result for the path loss caused by beam direction mismatch. For instance, the UE may first determine the path loss between the UE and a neighbor satellite, and then compensate the measurement result of the neighbor satellite by adding a gain to the measured reference signal received power (RSRP) or signal-to-noise ratio (SNR) based on the path loss. Alternatively, the network node may do the compensation using, e.g., a fixed formula with parameters based on the beam width information reported by the UE.

Under a second proposed scheme of the present disclosure, a UE (e.g., a VSAT UE) may indicate, in the UE capability information, the need or no need of an interruption for measurement/handover associated with certain satellite(s), based on its support of multiple simultaneous beam. In some implementations, the UE capability information may include an indication that the UE supports simultaneously operating with multiple beams associated with multiple satellites, and/or the number of the multiple beams, where the multiple beams may be applicable to simultaneous reception (only), simultaneous reception and measurement (only), simultaneous transmission (only), or simultaneous transmission, reception, and measurement. For instance, a UE supporting simultaneous reception and measurement does not require an interruption for antenna re-steering for measuring neighboring satellites. Alternatively, a UE supporting simultaneous reception may support dual connectivity to multiple satellites simultaneously, and if this UE does not support simultaneous transmission, then the transmissions to the multiple satellites may be interlaced/multiplexed in time.

### Illustrative Implementations

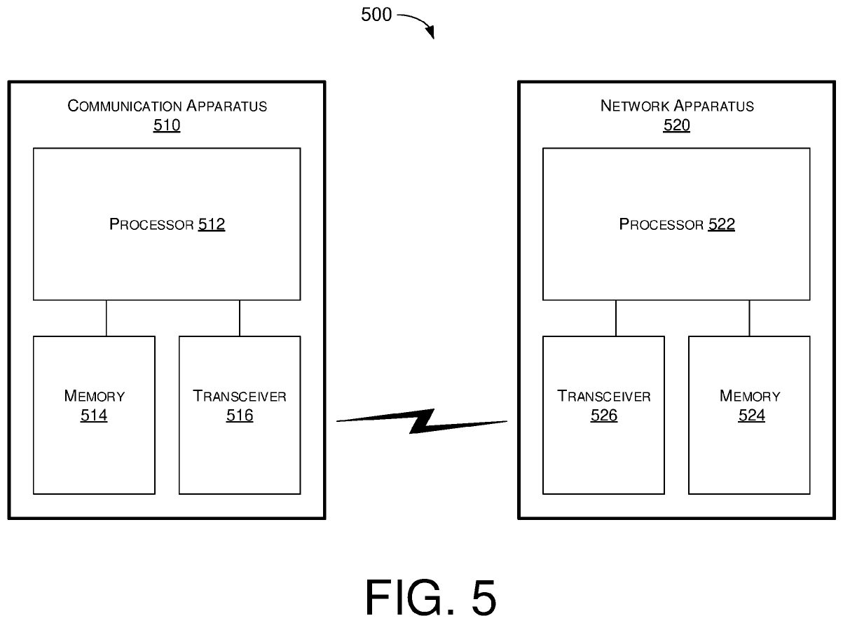

FIG. 5 illustrates an example communication system 500 having an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to inter-satellite measurement and handover for NTN in wireless communications, including scenarios/schemes described above as well as processes 600 and 700 described below.

Communication apparatus 510 may be a part of an electronic apparatus, which may be a VSAT UE such as a wireless communication apparatus or a computing apparatus, which may be mounted on a ship or vehicle, or installed on the roof a building (e.g., home or office), to provide internet access through satellite communications. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of an electronic apparatus, which may be a network node such as a satellite, a BS, a small cell, a router or a gateway of an NTN. For instance, network apparatus 520 may be implemented in a satellite and/or an eNB/gNB/TRP in a 4G/5G, NR, IoT, NB-IOT or IIoT network. Alternatively, network apparatus 520 may be implemented in the form of one or more IC chips such as, for example and without limitation, one or more single-core processors, one or more multi-core processors, or one or more RISC or CISC processors. Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks, including inter-satellite measurement and handover for NTN, in a device (e.g., as represented by communication apparatus 510) and a network node (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In some implementations, transceiver 516 may be capable of wirelessly communicating with different types of UEs and/or wireless networks of different radio access technologies (RATs). In some implementations, transceiver 516 may be equipped with a plurality of antenna ports (not shown) such as, for example, four antenna ports. That is, transceiver 516 may be equipped with multiple transmit antennas and multiple receive antennas for multiple-input multiple-output (MIMO) wireless communications. In some implementations, transceiver 516 may be equipped with a rotor if mechanical steering antenna is used. Alternatively, transceiver 516 may be equipped with phase antenna(s) if electronic steering antenna is used. In some implementations, network apparatus 520 may also include a transceiver 526 coupled to processor 522. Transceiver 526 may include a transceiver capable of wirelessly transmitting and receiving data. In some implementations, transceiver 526 may be capable of wirelessly communicating with different types of UEs of different RATs. In some implementations, transceiver 526 may be equipped with a plurality of antenna ports (not shown) such as, for example, four antenna ports. That is, transceiver 526 may be equipped with multiple transmit antennas and multiple receive antennas for MIMO wireless communications.

In some implementations, communication apparatus 510 may further include a memory 514 coupled to processor 512 and capable of being accessed by processor 512 and storing data therein. In some implementations, network apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 510 and network apparatus 520 may be a communication entity capable of communicating with each other using various proposed schemes in accordance with the present disclosure. For illustrative purposes and without limitation, a description of capabilities of communication apparatus 510, as a UE, and network apparatus 520, as a network node (e.g., satellite), is provided below with processes 600 and 700.

### Illustrative Processes

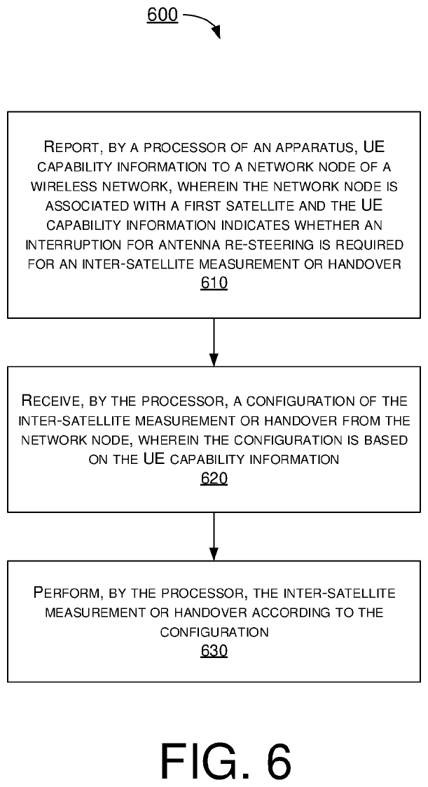

FIG. 6 illustrates an example process 600 in accordance with an implementation of the present disclosure. Process 600 may be an example implementation of above scenarios/schemes, whether partially or completely, with respect to inter-satellite measurement and handover for NTN in wireless communications. Process 600 may represent an aspect of implementation of features of communication apparatus 510. Process 600 may include one or more operations, actions, or functions as illustrated by one or more of blocks 610 to 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by or in communication apparatus 510 or any suitable UE. Solely for illustrative purposes and without limitation, process 600 is described below in the context of communication apparatus 510 as a UE. Process 600 may begin at block 610.

At 610, process 600 may involve processor 512 of communication apparatus 510 reporting, via transceiver 516, UE capability information to a network node (e.g., network apparatus 520) of a wireless network (e.g., an NTN), wherein the network node is associated with a first satellite and the UE capability information indicates whether an interruption for antenna re-steering is required for an inter-satellite measurement or handover. Process 600 may proceed from 610 to 620.

At 620, process 600 may involve processor 512 receiving, via transceiver 516, a configuration of the inter-satellite measurement or handover from the network node, wherein the configuration is based on the UE capability information. Process 600 may proceed from 620 to 630.

At 630, process 600 may involve processor 512 performing, via transceiver 516, the inter-satellite measurement or handover according to the configuration.

In some implementations, the UE capability information may include at least one of the following: an indication that the interruption for antenna re-steering is required for the inter-satellite measurement or handover associated with one or more second satellites; and an antenna re-steering duration for the one or more second satellites with which the interruption for antenna re-steering is required for the inter-satellite measurement or handover.

In some implementations, the UE capability information may include at least one of the following: an indication that the interruption for antenna re-steering is not required for the inter-satellite measurement or handover associated with the one or more second satellites; and a number of the one or more second satellites with which the interruption for antenna re-steering is not required for the inter-satellite measurement or handover.

In some implementations, the UE capability information may include beam width information.

In some implementations, the beam width information may include at least one of the following: (i) a beam width in degrees; (ii) a beam width angle; (iii) a number of antennas; (iv) an antenna array configuration; and (v) an antenna aperture and selectivity.

In some implementations, process 600 may further involve processor 512 determining a path loss between communication apparatus 510 and a second satellite associated with the inter-satellite measurement, and compensating a measurement result of the inter-satellite measurement based on the path loss.

In some implementations, the UE capability information may include at least one of the following: an indication that communication apparatus 510 supports simultaneously operating with multiple beams associated with multiple satellites; and a number of the multiple beams.

In some implementations, the multiple beams associated with the multiple satellites may be applicable to one of the following: (i) simultaneous reception; (ii) simultaneous reception and measurement; (iii) simultaneous transmission; and (iv) simultaneous transmission, reception, and measurement.

In some implementations, the UE capability information may indicate that the interruption for antenna re-steering is not required for the inter-satellite measurement or handover in an event that the multiple beams associated with the multiple satellites are applicable to simultaneous reception and measurement.

In some implementations, communication apparatus 510 may support dual connectivity to the multiple satellites simultaneously in an event that the multiple beams associated with the multiple satellites are applicable to simultaneous reception.

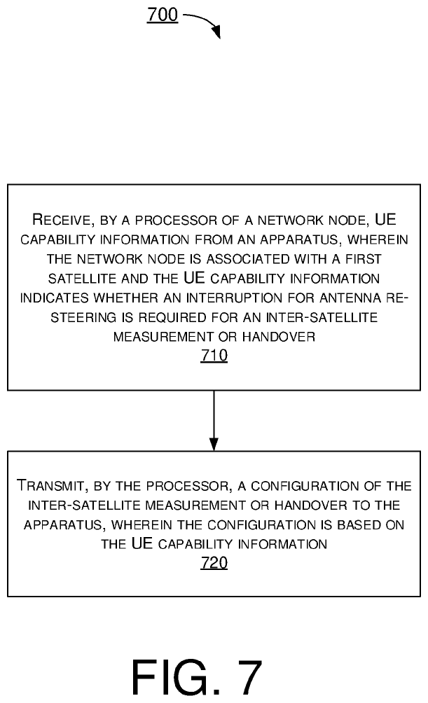

FIG. 7 illustrates an example process 700 in accordance with another implementation of the present disclosure. Process 700 may be an example implementation of above scenarios/schemes, whether partially or completely, with respect to inter-satellite measurement and handover for NTN in wireless communications. Process 700 may represent an aspect of implementation of features of network apparatus 520. Process 700 may include one or more operations, actions, or functions as illustrated by one or more of blocks 710 and 720. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by or in network apparatus 520 as well as any variations thereof. Solely for illustrative purposes and without limitation, process 700 is described below in the context of network apparatus 520 as a network At 710, process 700 may involve processor 522 of network apparatus 520 receiving, via transceiver 526, UE capability information from an apparatus (e.g., communication apparatus 510), wherein network apparatus 520 is associated with a first satellite and the UE capability information indicates whether an interruption for antenna re-steering is required for an inter-satellite measurement or handover. Process 700 may proceed from block 710 to block 720.

At 720, process 700 may involve processor 522 transmitting, via transceiver 526, a configuration of the inter-satellite measurement or handover to the apparatus, wherein the configuration is based on the UE capability information.

In some implementations, the UE capability information may include at least one of the following: an indication that the interruption for antenna re-steering is required for the inter-satellite measurement or handover associated with one or more second satellites; and an antenna re-steering duration for the one or more second satellites with which the interruption for antenna re-steering is required for the inter-satellite measurement or handover.

In some implementations, the UE capability information may include at least one of the following: an indication that the interruption for antenna re-steering is not required for the inter-satellite measurement or handover associated with the one or more second satellites; and a number of the one or more second satellites with which the interruption for antenna re-steering is not required for the inter-satellite measurement or handover.

In some implementations, the UE capability information may include beam width information.

In some implementations, the beam width information may include at least one of the following: (i) a beam width in degrees; (ii) a beam width angle; (iii) a number of antennas; (iv) an antenna array configuration; and (v) an antenna aperture and selectivity.

In some implementations, process 700 may further involve processor 522 compensating a measurement result of the inter-satellite measurement based on the beam width information.

In some implementations, the UE capability information may include at least one of the following: an indication that communication apparatus 510 supports simultaneously operating with multiple beams associated with multiple satellites; and a number of the multiple beams.

In some implementations, the multiple beams associated with the multiple satellites may be applicable to one of the following: (i) simultaneous reception; (ii) simultaneous reception and measurement; (iii) simultaneous transmission; and (iv) simultaneous transmission, reception, and measurement.

In some implementations, the UE capability information may indicate that the interruption for antenna re-steering is not required for the inter-satellite measurement or handover in an event that the multiple beams associated with the multiple satellites are applicable to simultaneous reception and measurement.

In some implementations, process 700 may further involve processor 522 determining that the apparatus supports dual connectivity to the multiple satellites simultaneously in an event that the multiple beams associated with the multiple satellites are applicable to simultaneous reception.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
reporting, by a processor of an apparatus, user equipment (UE) capability information to a network node of a wireless network, wherein the network node is associated with a first satellite and the UE capability information indicates whether an interruption for antenna re-steering is required for an inter-satellite measurement or handover;
receiving, by the processor, a configuration of the inter-satellite measurement or handover from the network node, wherein the configuration is based on the UE capability information; and
performing, by the processor, the inter-satellite measurement or handover according to the configuration.

2. The method of claim 1, wherein the UE capability information comprises at least one of the following:
an indication that the interruption for antenna re-steering is required for the inter-satellite measurement or handover associated with one or more second satellites; and
an antenna re-steering duration for the one or more second satellites with which the interruption for antenna re-steering is required for the inter-satellite measurement or handover.

3. The method of claim 1, wherein the UE capability information comprises at least one of the following:
an indication that the interruption for antenna re-steering is not required for the inter-satellite measurement or handover associated with the one or more second satellites; and
a number of the one or more second satellites with which the interruption for antenna re-steering is not required for the inter-satellite measurement or handover.

4. The method of claim 1, wherein the UE capability information comprises beam width information.

5. The method of claim 4, wherein the beam width information comprises at least one of the following:
a beam width in degrees;
a beam width angle;
a number of antennas;
an antenna array configuration; and

6. The method of claim 1, further comprising:
determining, by the processor, a path loss between the apparatus and a second satellite associated with the inter-satellite measurement; and
compensating, by the processor, a measurement result of the inter-satellite measurement based on the path loss.

7. The method of claim 1, wherein the UE capability information comprises at least one of the following:
an indication that the apparatus supports simultaneously operating with multiple beams associated with multiple satellites; and
a number of the multiple beams.

8. The method of claim 7, wherein the multiple beams associated with the multiple satellites are applicable to one of the following:
simultaneous reception;
simultaneous reception and measurement;
simultaneous transmission; and
simultaneous transmission, reception, and measurement.

9. The method of claim 8, wherein the UE capability information indicates that the interruption for antenna re-steering is not required for the inter-satellite measurement or handover in an event that the multiple beams associated with the multiple satellites are applicable to simultaneous reception and measurement.

10. The method of claim 8, wherein the apparatus supports dual connectivity to the multiple satellites simultaneously in an event that the multiple beams associated with the multiple satellites are applicable to simultaneous reception.

11. A method, comprising:
receiving, by a processor of a network node, user equipment (UE) capability information from an apparatus, wherein the network node is associated with a first satellite and the UE capability information indicates whether an interruption for antenna re-steering is required for an inter-satellite measurement or handover; and
transmitting, by the processor, a configuration of the inter-satellite measurement or handover to the apparatus, wherein the configuration is based on the UE capability information.

12. The method of claim 11, wherein the UE capability information comprises at least one of the following:
an indication that the interruption for antenna re-steering is required for the inter-satellite measurement or handover associated with one or more second satellites; and
an antenna re-steering duration for the one or more second satellites with which the interruption for antenna re-steering is required for the inter-satellite measurement or handover.

13. The method of claim 11, wherein the UE capability information comprises at least one of the following:
an indication that the interruption for antenna re-steering is not required for the inter-satellite measurement or handover associated with the one or more second satellites; and
a number of the one or more second satellites with which the interruption for antenna re-steering is not required for the inter-satellite measurement or handover.

14. The method of claim 11, wherein the UE capability information comprises beam width information.

15. The method of claim 14, wherein the beam width information comprises at least one of the following:
a beam width in degrees;
a beam width angle;
a number of antennas;
an antenna array configuration; and
an antenna aperture and selectivity.

16. The method of claim 14, further comprising:
compensating, by the processor, a measurement result of the inter-satellite measurement based on the beam width information.

17. The method of claim 11, wherein the UE capability information comprises at least one of the following:
an indication that the apparatus supports simultaneously operating with multiple beams associated with multiple satellites; and
a number of the multiple beams.

18. The method of claim 17, wherein the multiple beams associated with the multiple satellites are applicable to one of the following:
simultaneous reception;
simultaneous reception and measurement;
simultaneous transmission; and
simultaneous transmission, reception, and measurement.

19. The method of claim 18, wherein the UE capability information indicates that the interruption for antenna re-steering is not required for the inter-satellite measurement or handover in an event that the multiple beams associated with the multiple satellites are applicable to simultaneous reception and measurement.

20. The method of claim 18, further comprising:
determining, by the processor, that the apparatus supports dual connectivity to the multiple satellites simultaneously in an event that the multiple beams associated with the multiple satellites are applicable to simultaneous reception.
